(19) United States
(12) Patent Application Publication
(10) Pub. No.: US 2010/0242320 A1
(43) Pub. Date: Sep. 30, 2010

(54) LABEL TAG CORD

(76) Inventor: Ying-Che HUANG, Taipei City (TW)

Correspondence Address: EGBERT LAW OFFICES, 412 MAIN STREET, 7TH FLOOR, HOUSTON, TX, 77002, US

(21) Appl. No.: 12/410,907

(22) Filed: Mar. 25, 2009

(51) Int. Cl. G09F 3/08; A44B 21/00

(52) U.S. Cl. 40/316; 24/460

(57) ABSTRACT

The present invention is a label tag cord used as a connector between the label tag and the product or as an independent identifier. The label tag cord includes a linearly extending and pliable cord body. At the two ends in the extending directions of the cord body, a first positioning part and a second positioning part are configured. An identifying surface is integrally formed at a preset position between the first and second positioning part and is in the form of an expanded area compared to the cord body, so that a trademark can be printed or etched on the identifying surface.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a label tag cord, and more particularly to an innovative cord with an additional identifying surface for a trademark imprint.

2. Description of Related Art Including Information Disclosed Under 37 CFR 1.97 and 37 CFR 1.98.

Companies in various industries need to build their own brands or reputation. For this purpose, they use their own trademarks or logos to differentiate products and to build awareness. A label tag is a common means to promote product brands and is widely used on garments, tools, and toys. A label tag is connected with the product usually through a label tag cord. There are quite a few names for a label tag cord, such as a row nail and a plastic nail. These devices present a structural improvement of the plain label tag cord.

Prior art label tag cords are very simple in structure and can be piled or rolled regularly, and therefore are suitable for massive production with high productivity. However, such prior art label tag cords also have their shortcomings. Due to the simple structure of the label tag cord, the whole structure, including the cord body and the positioning end, has a very small area, and it is difficult to identify with the naked eye its manufacturer or distributor and its brand. Therefore, it is unable to notably display its brand and value. This is regretful and is a problem.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The label tag cord disclosed in the present invention features an innovative and unique structure of an identifying surface integrally formed on a cord body. The expanded area of the identifying surface can provide a marking place to be printed or etched with a trademark, so as to highlight and promote the brand of the product, and consequently increase the advertising effect and enhance the product value. Hence, the present invention has a good value for industrialization.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of a preferred embodiment of the present invention.

FIG. 2 shows a perspective view of another embodiment of the identifying surface of the present invention.

FIG. 3 shows a perspective view of another embodiment of the identifying surface of the present invention.

FIG. 4 shows a perspective view of another embodiment of the present invention.

FIG. 5 shows a perspective view of an illustration of the working status of another embodiment of the present invention.

FIG. 6 shows a schematic view of the use of the embodiment of FIG. 1 of the present invention.

FIG. 7 shows another schematic view of the use of the embodiment of FIG. 1 of the present invention.

FIG. 8 shows a schematic view of another embodiment of the present invention.

FIG. 9 shows a schematic view of the use of the embodiment of FIG. 7 of the present invention.

### DETAILED DESCRIPTION OF THE INVENTION

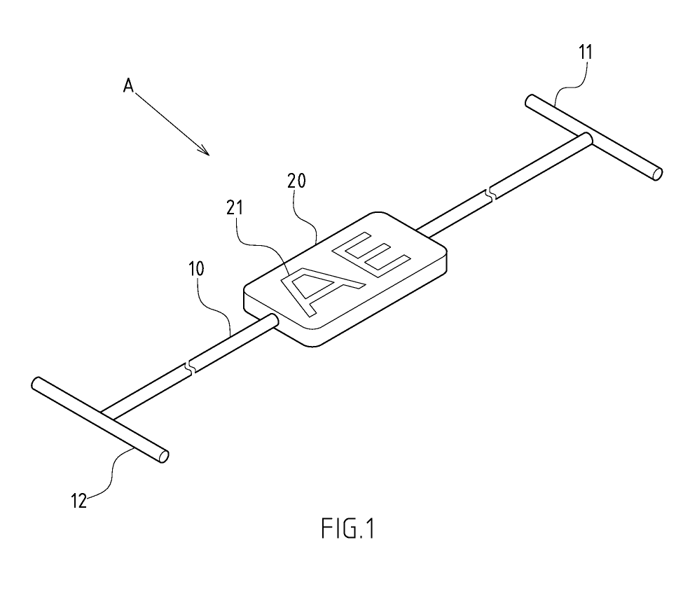

FIG. 1 shows a preferred embodiment of the structural improvement of label tag cord according to the present invention. While such an embodiment is for descriptive purposes only, its structure shall not in any way restrict the scope of patent application.

The label tag cord A is used as a connector between the label tag and the product, or as an independent identifier.

The label tag cord A comprises a cord body 10, linearly extending and pliable. At the two ends in the extending directions of the cord body 10, a first positioning part 11 and a second positioning part 12 are configured. The label tag cord A can be of plastic material.

An identifying surface 20 is integrally formed at a preset position between the first and second positioning part 11, 12 of the cord body 10. The identifying surface 20 is in the form of an expanded area comparing to the cord body 10. A trademark 21 can be printed or etched on the identifying surface 20 for brand promotion. Apart from this, the identifying surface 20 can also be printed with graphic designs or patterns for better visibility.

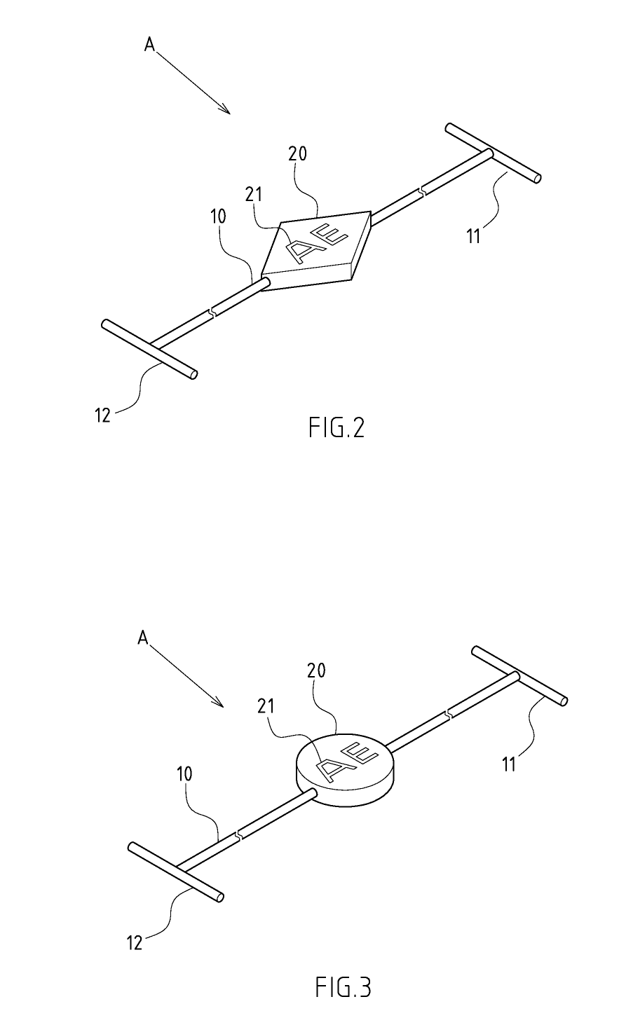

As shown in FIGS. 1, 2, and 3, the identifying surface 20 can be in any geometric shape, such as rectangle (as shown in FIG. 1), rhombus (as shown in FIG. 2), or circle (as shown in FIG. 3), to be selected according to the appearance of the trademark 21 for a good visual experience, and also for direct identification of the manufacturer or distributor of the product by the naked eye.

The particular forms of the label tag cord A are depicted in FIGS. 1, 2, and 3. The first positioning part 11 of the label tag cord A is configured to be in the shape of a bar vertically connected to the cord body 10, and the second positioning part 12 can be configured in the shape of a bar or strip vertically connected to the cord body 10. In the embodiment of the present invention, the first and second positioning part 11, 12 are both in the shape of a bar vertically connected to the cord body 10.

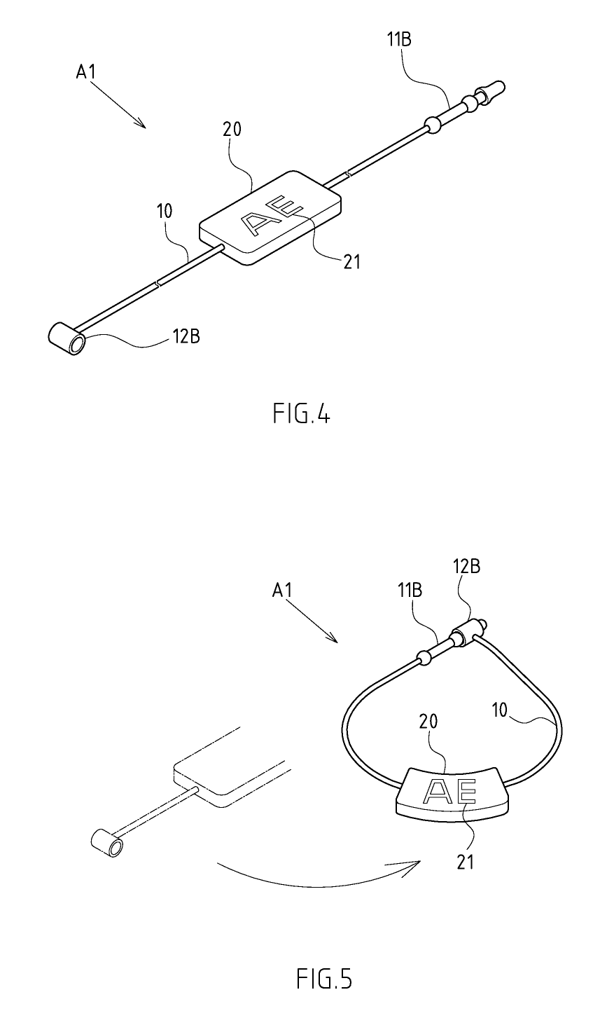

FIGS. 4 and 5 depict another embodiment of the present invention, where the first positioning part 11B can also be a male inserter, and the second positioning part 12B can be a female clasp. The female clasp is a conic and hollow clasp, while the male inserter is in the shape of a conic inserter with nodes. Based on the node of the first positioning part 11B, after inserting the first positioning part 11B into the second positioning part 12B, the male inserter can be locked in the hollow clasp, and the front end of the male inserter will protrude out of the hollow clasp. Such an assembly makes the label tag cord A1 into a ring shape.

The above structures constitute the structures of the present invention. The usage and working status of the present invention are described as follows.

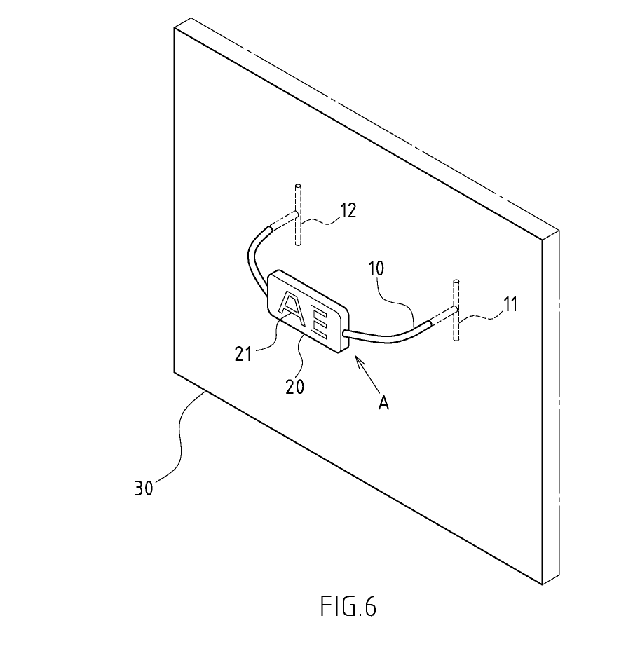

In the embodiment shown in FIG. 6, the first and second positioning part 11, 12 of the label tag cord A are both in the shape of a bar vertically connected to the cord body 10. The first positioning part 11 and second positioning part 12 both pierce into the same object 30 and are locked at two positions spaced with an interval, and the identifying surface 20 is displayed and positioned outside the object 30. Said object 30 is fabric or soft film that can be penetrated by a hard object.

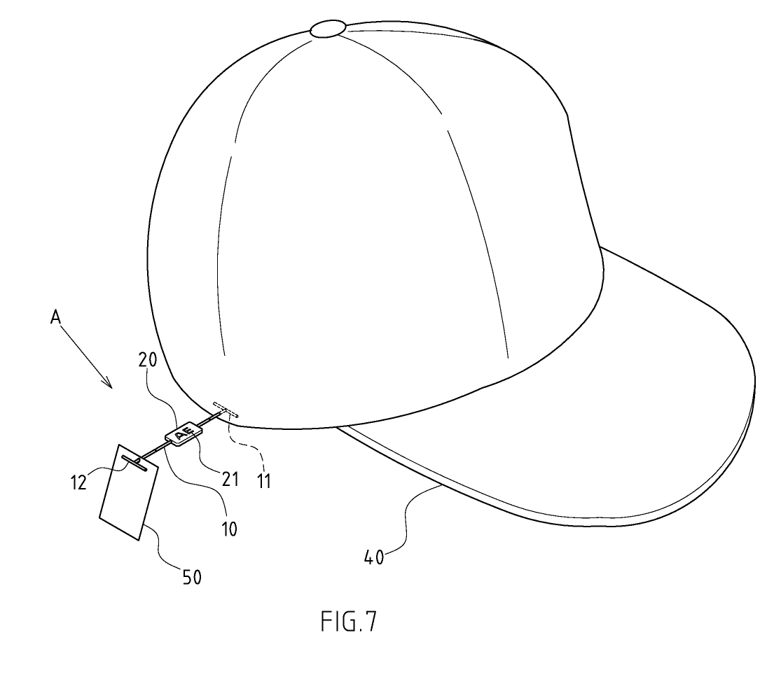

Referring to FIG. 7, said first positioning part 11 of the label tag cord A pierces into and is locked on the first object 40 which is fabric or soft film that can be penetrated by a hard object, and the second positioning part 12 pierces into and is locked on the second object 50 which is a label tag. In this way, the label tag cord A has double positioning functions. Through the identifying surface 20, the brand of the product can be highlighted.

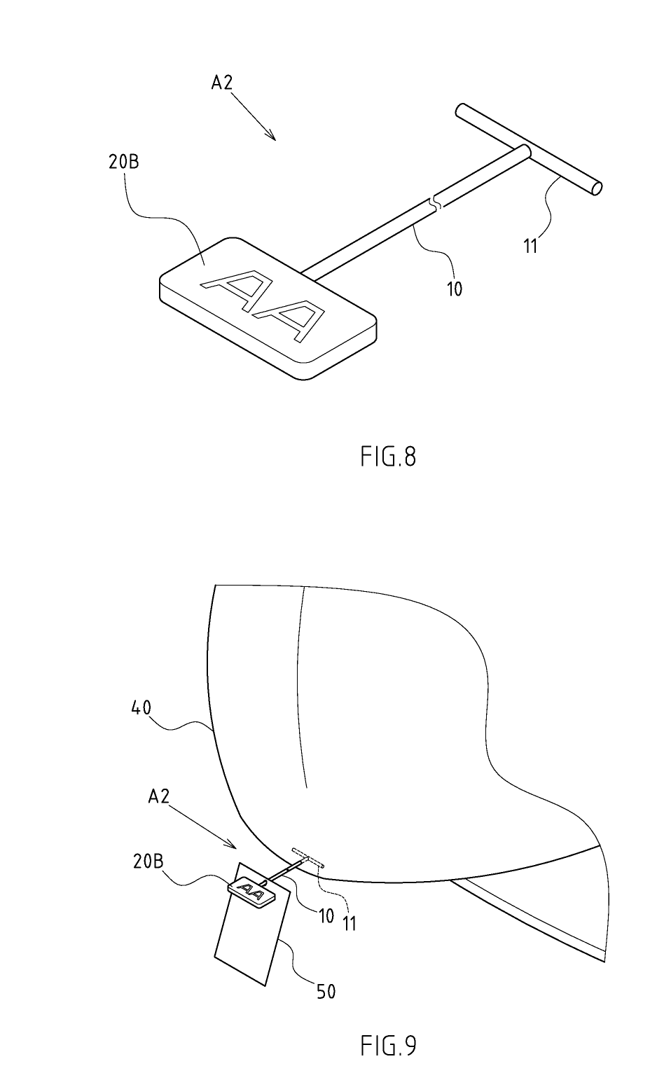

In the embodiment shown in FIG. 8, the label tag cord A2 is in the shape of another variation. The identifying surface 20B of the label tag cord A2 is configured on the opposite end of the first positioning part 11. The first positioning part 11 pierces into and is locked on the first object 40, while the second object 50 is blocked by the identifying surface 20B (please refer to FIG. 9). In this way, the identifying surface 20B has dual functions of brand promotion and positioning.

1-11. (canceled)

12. A cord article comprising:
a cord having a first end and a second cord, said cord extending linearly and being pliable, said cord having a cross-sectional diameter;
a first positioning part extending transverse to said cord at said first end, said first positioning part having a length substantially greater than said cross-sectional diameter of said cord, said first positioning part having a diameter;
a second positioning part extending transverse to said cord at said second end, said second positioning part having a length substantially greater than said cross-sectional diameter of said cord, said second positioning part having a diameter substantially equal to said diameter of said first positioning part; and
an identification surface positioned on said cord between said first positioning part and said second positioning part, said identification surface having a thickness greater than said cross-sectional diameter of said cord, said identification surface having a width substantially greater than said cross-sectional diameter of said cord, said identification surface having an indica formed thereon, said cord and said first positioning part and said second positioning part and said identification surface being integrally formed together of a polymeric material.

13. The cord article of claim 12, said identification surface having a shape selected from the group consisting of a rectangle, a rhombus, a circle and a polygon.

14. The cord article of claim 12, each of said first and second positioning parts being of a bar shape.

15. The cord article of claim 12, further comprising:
a first object into which one of said first and second positioning parts has penetrated, said identification surface being positioned exterior of said first object.

16. The cord article of claim 15, said object being a fabric.

17. The cord article of claim 15, further comprising:
a second object into which the other of said first and second positioning parts has penetrated, said identification surface positioned between said first and second objects.

18. The cord article of claim 17, said second object being a label tag.

19. The cord article of claim 12, said indicia selected from the group consisting of a trademark, a graphic design and a pattern.

20. A cord assembly comprising:
a cord having a first end and a second cord, said cord extending linearly and being pliable, said cord having a cross-sectional diameter;
a female clasp formed at said first end of said cord;
a male inserter formed at said second end of said cord, said male inserter suitable for fixed insertion within said female clasp; and
an identification surface positioned on said cord between said female clasp and said male inserter, said identification surface having a thickness greater than said cross-sectional diameter of said cord, said identification surface having a width substantially greater than said cross-sectional diameter of said cord, said identification surface having indicia thereon, said cord and said female clasp and said male inserter and said identification surface being integrally formed of a polymeric material.
